(19) United States
(12) Patent Application Publication
(10) Pub. No.: US 2005/0282574 A1
(43) Pub. Date: Dec. 22, 2005

(54) Power controlling method based on DwPTS

(75) Inventors: Shihe Li, Beijing (CN); Guiliang Yang, Beijing (CN)

Correspondence Address: MARSHALL, GERSTEIN & BORUN LLP, 233 S. WACKER DRIVE, SUITE 6300, SEARS TOWER, CHICAGO, IL, 60606, US

(73) Assignee: Da Tang Mobile Communications Equipment Co., Ltd., Beijing (CN)

(21) Appl. No.: 11/177,844

(22) Filed: Jul. 8, 2005

Related U.S. Application Data
(63) Continuation of application No. PCT/CN04/00061, filed on Jan. 16, 2004.

(30) Foreign Application Priority Data
Jan. 16, 2003 (CN) 03114938.3

(51) Int. Cl. H04Q 7/20

(52) U.S. Cl. 455/522; 455/69

(57) ABSTRACT

A power-control method base on Downlink Piloting Time Slot (DwPTS) in a mobile communication system. While a terminal is being accessed randomly, the terminal determines the transmitting signal power at Uplink Piloting Time Slot (UpPTS) for open-loop power control by using broadcast information and the measured DwPTS power. While the communications are being maintained, the base station notifies the terminal of the required receiving power, the terminal then calculates the transmitting power for open-loop power control by using the measured DwPTS power, which is taken as the reference transmission power of the uplink channel and compared with the actual transmitting power required by the base station for closed-loop power control; the difference of the comparison is in turn compared with a threshold, if the difference is larger than the threshold, sum of the reference transmission power and the threshold is used as the power to perform transmission, otherwise, the closed-loop power control command is keeping executed. By taking the advantage of the TDD mode in which the uplink and downlink transmissions are, carried out in the same conditions, the method makes full use of open-loop power control which has the merits of being simple and accurate so that complex outer-loop power control is not needed in closed-loop power control, making the RNC simpler and the system more stable. hi addition, since it is the DwPTS power that is measured in the power control, the accuracy of power control is greatly improved.

### CROSS-REFERENCE TO RELATED APPLICATION

This is a continuation of PCT/CN2004/000061 filed Jan. 16, 2004, the entire disclosure of which is incorporated herein by reference.

### BACKGROUND OF THE INVENTION

1. Field of the Technology

The invention relates generally to a power control method in a mobile communication system and, more particularly, to a power control method based on Downlink Piloting Time Slot (DwPTS) in a mobile communication system.

2. Related Technology

Power control is a traditional and important technology in a CDMA mobile communication system. In the third generation mobile communication system, the “open-loop control+closed-loop control+outer-loop control” mode is adopted. The open-loop power control method is described in the published TS 25.331 of 3GPP Specification (Version 2002.3, Release 99 and Release 4), while the closed-loop power control is described in TS 25.214 and TS 25.224. Besides, support to the mechanism of outer-loop power control is provided in TS 25.331 and TS 25.433.

Taking the Low Chip Rate Time Division Duplex (LCR TDD) standard in 3GPP as example, the basic approaches of the three power control methods are as follows.

For open-loop power control, a base station broadcasts transmission power of a downlink public channel (P-CCPCH), and meanwhile broadcasts the expected transmission power of an uplink public channel (SYNC_UL); a terminal, before sending SYNC_UL, measures actual receiving power of the downlink public channel (P-CCPCH) and reads transmission power of this channel in the broadcast information, the difference between the two powers being the path transmission loss of a signal. According to the path transmission loss and the expected transmission power of the uplink public channel in the broadcast information, the terminal can determine its own transmission power of uplink SYNC_UL. In the open-loop power control method, it is assumed that uplink path transmission loss and downlink path transmission loss are equal. In a Frequency Division Duplex (FDD) system (such as UTRA FDD in 3GPP Specification), since different carrier frequencies are adopted in uplink and downlink transmissions and the transmission conditions of electric waves are different, this assumption is inaccurate. Moreover, in a multi-code-channel working condition, multiple access interference inside the local cell is severe and it is difficult to accurately measure the signal power level received by the terminal, resulting in large error in the calculation of open-loop power control. On the other hand, in a Time Division Duplex (TDD) system (such as UTRA TDD in 3GPP Specification), since the same carrier frequency is adopted in uplink and downlink and the transmission condition for electric wave is the same, the above-noted assumption is relatively accurate. Therefore, in terms of calculation accuracy of open-loop power control, a TDD system is better than an FDD system.

However, in a TDD system there is severe interference among P-CCPCH channels of adjacent cells and there is severe error in the P-CCPCH signal power level sent by a base station as measured by a terminal. In this case, accuracy of open-loop power control is limited. As a result, in the low chip rate TDD standard, application of open-loop power control is limited to the random access phase and not recommended in the communication maintenance phase.

In a CDMA system, a terminal usually adopts closed-loop power control during communications. In closed-loop power control, power control is implemented by the base station which measures and judges the received Signal to Interference Noise Ratio (SIR). If SIR is higher than the required threshold, the terminal is required to reduce the signal power level through a control command; in contrast, if SIR is lower than the required threshold, the terminal is required to increase the signal power level through a control command. With this method, not only a base station can obtain the required service quality, but also the system capacity is guaranteed. The main problem of closed-loop power control, however, is the so called “cocktail party effect.” A base station will request a terminal to increase transmission power because of interference in the system or other reasons. However, due to the self-interference characteristic of a CDMA system, increase of the transmission power of a terminal will lead to increase of interference to other terminals, which, in turn, will make the system request other terminals to increase transmission power, resulting in larger interference to the current terminal. If this continues in cycles, transmission power of a terminal is becoming larger and larger and so is the interference thereto while the system capacity becomes smaller and smaller. Finally the cell will be congested. To avoid the “cocktail party effect,” an outer-loop power control procedure is needed to restrain closed-loop power control.

The outer-loop power control procedure is controlled by high hierarchy signaling. The procedure comprises primarily setting power control thresholds (i.e. target values of SIR) in connection with each terminal by the system for a base station according to the network configuration, system capacity and required quality of the provided service, and actual quality of the current service (e.g. Error Rate (FER)), so as to achieve the best possible matching between.system performance and capacity. As the existing FDD systems are all severe interference-limited systems, a large number of research papers concerning outer-loop power control have been published in order to keep the capacity as high as possible, leading to more and more complicated algorithms and increasing load for a Radio Network Controller (RNC).

To sum up, since it is not possible to get a high accuracy of power measurement and there are other factors like multi-path broadcast and fast fading, power control has always been a critical issue in a CDMA system. Although open-loop power control is simple, there may be large errors if P-CCPCH is measured for getting the transmission loss, which limits the application of open-loop power control during the period while the communications are maintained. On the other hand, because of the “cocktail party effect,” closed-loop power control must depend on outer-loop power control procedure. In the current CDMA communication standard (referring to the third generation mobile communication standards in 3GPP and 3GPP2), outer-loop power control is fully incorporated and accomplished within a base station controller. A base station controller would control dozens, even hundreds, of base stations and there would be thousands of terminals communicating simultaneously within the controlling scope of this base station controller. As all the power controls have to be done by this base station controller, the load is too heavy and devices are too complicated.

### SUMMARY OF THE INVENTION

The invention provides a power control method based on DwPTS to overcome shortcomings of the prior art.

The method of the invention utilizes the following power control method based on DwPTS which comprises an open-loop power control procedure while a terminal is being accessed randomly and a closed-loop power control procedure while communications are being maintained after the terminal is accessed, wherein the open-loop power control procedure while a terminal is being accessed randomly further comprises:

A. the terminal measuring the received DwPTS signal powers transmitted by adjacent base stations during cell searching, sorting the base stations in the order of signal strength of DwPTS, and determining candidate base stations;

B. the terminal calculating the Uplink Piloting Time Slot (UpPTS) transmission power for open-loop power control while the terminal is being accessed according to the base station transmission power broadcasted by a candidate base station, the expected receiving power and the DwPTS signal power of the base station actually measured by the terminal, and sending an access request to the base station with this transmission power; and,

the closed-loop power control procedure. after the terminal is accessed further comprises:

C. the base station determining the required receiving power, determining actual uplink transmission power required by the base station for closed-loop power control, sending the required receiving power to the terminal, and sending the actual uplink transmission power required by the base station to the terminal with a closed-loop power control command;

D. the terminal keeping measuring the actually received DwPTS signal power of the base station, then calculating an uplink transmission power reference value for open-loop power control according to the base station transmission power and the required receiving power; and

E. comparing the calculated uplink transmission power reference value for open-loop power control with the actual uplink transmission power required by the base station for closed-loop control and obtaining a difference, comparing the difference with a threshold; if the difference is larger than the threshold, the terminal performing uplink transmission with the power which is equal to the sum of the calculated uplink transmission power reference value for open-loop power control and the threshold, if the difference is not larger than the threshold, the terminal continuing to execute the closed-loop power control command and performing uplink power transmission with the actual transmission power required by the base station for closed-loop power control.

The power control method of the invention comprises an open-loop power control procedure while a terminal is being accessed randomly and a closed-loop power control procedure with participation of open-loop power control while communications are being maintained. In the open-loop power control, DwPTS signals with good relevant characteristics in the low chip rate TDD standard of 3GPP are used as measure objects, avoiding large errors brought about by measuring P-CCPCH. In the closed-loop power control, the open-loop power control is involved, namely utilizing the open-loop procedure to calculate an uplink transmission power according to DwPTS signal strength while the communications are maintained, and this calculated result obtained by using open-loop power control is taken as reference for the closed-loop power control. As this method can avoid the “cocktail party effect” in closed-loop power control, outer-loop power control may not be used anymore in closed-loop power control, which helps reduce the equipment complexity.

Based on the low chip rate TDD standard of 3GPP, the invention adopts the following technical scheme: when a terminal is getting a random access, the terminal determines the UpPTS transmission power for open-loop control according to the received DwPTS signal power from a base station so as to guarantee that the base station can correctly receive the signal, and then enters the closed-loop power control. When getting a random access, the terminal can obtain the setting of the base station by receiving the information of Base station Control Channel (BCCH) so that the open-loop control can achieve very high accuracy. During the communications, the terminal keeps measuring the DwPTS signal powers of the base station and calculates an average of the measured powers to determine an UpPTS transmission power reference value for open-loop power control. The terminal then compares this reference value with the actual transmission power required by the base station for closed-loop power control, the difference thereof will in turn be compared with a threshold so as to determine the uplink transmission power for closed-loop power control. As for services of different quality requirements, the base station will notify the terminal of the required strength of the receiving power whenever necessary, with which the terminal will determine UpPTS transmission power of the terminal for open-loop power control so as to guarantee the accuracy of closed-loop power control. Radio Network Controller (RNC) does not anticipate in the power control procedure and just provides settings for the base station.

Before randomly accessing, the terminal firstly searches for DwPTS from adjacent base stations and sorts the base stations based on the strength of the receiving powers. While searching for DwPTS sent by adjacent base stations, the terminal calculates the average of multiple measurements of the receive power of the DwPTS of each base station and sorts the average values from big to small. While being accessed, the terminal receives BCCH information of each base station in the order of the said sorting to determine the most suitable base station to access. By receiving the BCCH information of a base station, the terminal obtains the setting of the base station as well as the transmitting power level and the required receiving power level.

When being randomly accessed, the terminal will calculate P4, the transmitting power of UpPTS for being accessed according to P1, the transmitting power broadcasted by the base station, P2, the power that the base station expects to receive while the terminal is being accessed, and P3, the DwPTS power of the base station measured by the terminal with the formula P4=P1−P2+P3. Besides, a large increment of power should be added to the desired transmitting power for the terminal to get accessed when it is calculated by the terminal. With the desired transmitting power level obtained through the calculation, the terminal sends an access request to the base station at the UpPTS.

During communications, the terminal will calculates P5, the uplink transmission power reference value of the terminal according to P1, the base station's transmission power broadcasted by the base station, P2, the power that the base station expects to receive, and P3, the DwPTS power of the base station measured by the terminal with the formula P5=P1−P3+P2.

When the terminal and the base station are in communication, the base station transmits the required receiving power (P2) level value to the terminal according to the service quality requirement, and then enters the closed-loop power control. When the terminal and the base station are in communication, the terminal calculates the uplink transmission power reference value (level) under open-loop power control according to the measurement of the DwPTS power (P3), which can be the average of multiple power measurements of the DwPTS. According to the closed-loop power control command, when the transmitting power level required for the terminal (that is the actual transmitting power required by the base station) is larger than the uplink transmission power reference value, namely wxhen the difference between the two levels is larger than the threshold (closed-loop control threshold), the terminal will use the sum of this threshold and the actual transmission power required by the base station as the uplink transmission power. If the service is changed and the base station proposes a new required receiving power level for the terminal, the terminal will calculate the transmission power reference value for open-loop power control and new closed-loop control threshold according to this new level. RNC will only set the maximum transmission power of each time slot of a base station and the quality requirement of each service provided by the base station.

The invention makes use of the merits of simplicity and accuracy of open-loop power control by taking the advantage of TDD duplex mode having the same transmission conditions for uplink and downlink. With the method of the invention, the characteristic of the frame structure defined in the TD-SCDMA standard is employed to use the power level of DwPTS that is received and measured by the terminal from the base station and is relatively accurate as the basis of open-loop power control. As the relatively accurate measurement of DwPTS power level is used for power control instead of the power measurement of the working channel which has a larger error, accuracy of the power measurement is improved, so is the accuracy of power control. By means of the invention, the complicated outer-loop power control method is not needed so that the RNC structure is simpler and the system is more stable.

### BRIEF DESCRIPTION OF THE DRAWINGS

FIG. 1 is a flowchart illustrating the open-loop power control procedure while a terminal is being accessed randomly.

FIG. 2 is a flowchart illustrating the closed-loop power control procedure with the open-loop procedure participated during communications after the terminal is accessed.

FIG. 3 illustrates the structure of a TD-SCDMA frame.

### DETAILED DESCRIPTION OF THE INVENTION

In the invention, open-loop power control is adopted when a terminal is being accessed. Since a marked advantage of a TDD system is that uplink and downlink transmissions adopt the same carrier frequency, the uplink and downlink transmission characteristics of electric waves are almost the same in the same time period, which enables the open-loop power control of a TDD system to achieve a very high accuracy.

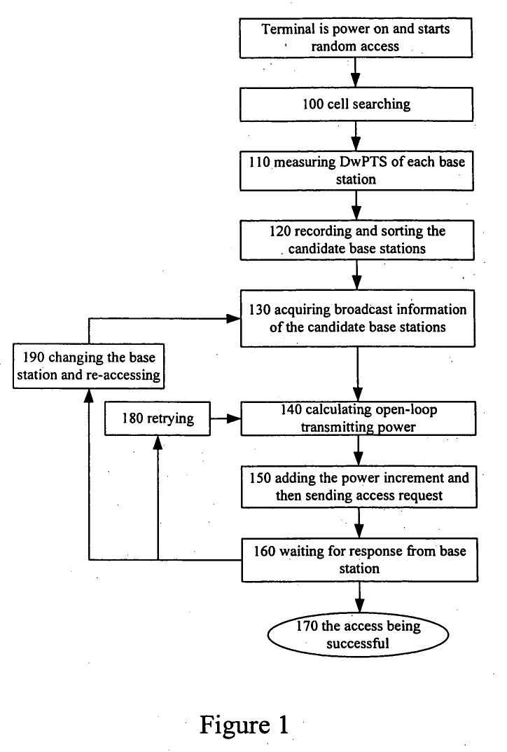

As shown in FIG. 1, when a terminal is power on and starts a random access procedure, the terminal will first search for DwPTS signals of adjacent base stations which may work with the same or different carrier frequencies (cell search 100), and measure the power (Pr) levels of the received DwPTS signals from these adjacent base stations, which can be done a plurality of times to get an average of the results so as to make the measurement more accurate, and moreover, to overcome error caused by fast fading (measuring DwPTS of each base station 110). Since all the base stations in a TD-SCDMA system work synchronously, transmitting DwPTS signals at the same time and employing codes of good correlation, it is very easy for the terminal to differentiate DwPTS signals of these base stations and sort them according to signal stength. After several base stations with the strongest DwPTS signals have been measured and recorded, they become the candidate base stations to be accessed (recoding and sorting candidate base stations 120).

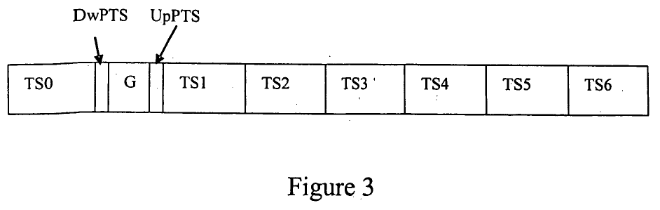

Then, broadcast channels of each candidate base station are received in proper order to obtain the message of the base station that is the most suitable to access (e.g. with the most intense signal of DwPTS according to the sorting) (acquiring broadcast information of the accessed base station 130). The transmitting power (Ptt) level of Uplink Piloting Time Slot (UpPTS, as shown in FIG. 3) for open-loop power control is then calculated for the base station most suitable to access (calculating open-loop transmission power 140). Ptt=Ptb−Prt+Preq+Pad, where Ptb is the transmission power (level) of the DwPTS signal of this base station; Prt is the DwPTS signal power (level) actually received and measured by the terminal; Preq is the receiving power (level) required by the base station; and Pad is an increment of transmitting power (level) of the terminal in order to prevent burst interference.

Through the above process (130), Preq, the receiving power (level) required by this base station and Ptb, the transmission power (level) of DwPTS signal of this base station are known (the accurate value of which can be acquired from the broadcast information of the base station). Prt can be obtained by actual measurement. Therefore, accuracy of the open-loop power control can be very high. Pad can be a relatively large numerical value, such as 10 dB.

With the calculated result: Ptb−Prt+Preq plus a power increment Pad, a random access request is sent to the base station (adding the power increment and then sending an access request 150). When being randomly accessed, the terminal is often in a fast fading environment, thus by adding a power increment Pad the access reliability can be improved. Furthermore, as only the access request is transmitted by the terminal in the UpPTS without any service data, as defined in the TD-SCDMA standard and shown in FIG. 3, no interference is possible for other clients. Even if the UpPTS is transmitted by the terminal's largest transmission power, there will not be an interference problem.

The terminal waits for the base station's response after transmitting a random access request thereto (160). If the terminal receives a response, which shows that the access is successful, the terminal enters the closed-loop power control procedure (170). In contrast, if the terminal receives no response, which shows that the access is unsuccessful, there are two ways to follow: one way is to retry after a certain period of delay, namely to try again on the current candidate base station (180), return to execute Step 140 and meanwhile record the number of retrying attempts, stop retrying when the retrying attempts reach a predefined number; the other way is to try to access other candidate base stations (selecting the base station with the next most intense signal of DwPTS according to the above said sorting to access 190), namely return to execute Step 130.

As mentioned above, a terminal in a CDMA system usually adopts closed-loop power control during on-going communications. However, the “cocktail party effect” of closed-loop power control makes it necessary for outer-loop power control to be participated so as to avoid the terminal's transmission power from continuously increasing under the circumstances of interference. The invention solves this problem by involving open-loop power control in the closed-loop power control procedure.

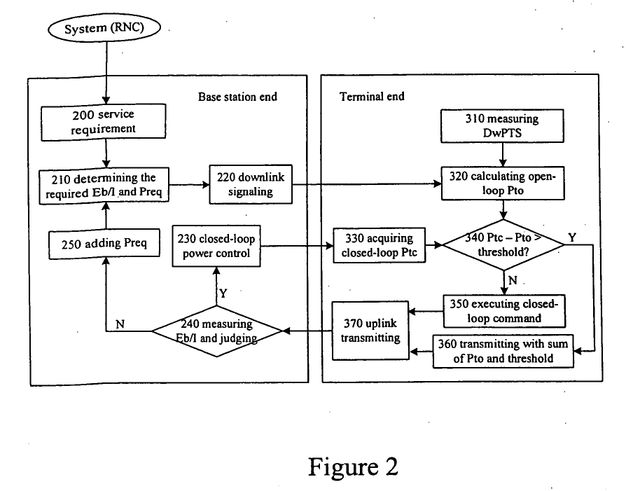

As shown in FIG. 2, during the communications, the base station determines the required Eb/I and required receiving power (level) Preq (210) according to Quality of Service (QoS) requirement (200), and notifies the terminal of the required receiving power (level) Preq through higher layer downlink signaling. Meanwhile, the base station measures the Eb/I of the uplink signal (240) according to the received uplink signal from the terminal, compares the measured Eb/I with the required Eb/I, and sends a closed-loop power control command (230) or adjusts Preq (250). While executing the closed-loop power control command, the terminal keeps measuring the DwPTS signal of the base station (310) and gets the time average of the received levels of the signal, which is used for calculating Pto, the power level that should be transmitted by the terminal under open-loop power control (320). Pto=Ptb−Prt+Preq, where Ptb and Preq are accurately known and Prt, the receiving power (level) measured at DwPTS is also relatively accurate. Therefore, the calculated Pto is relatively accurate as well. The calculated Pto is used as a reference and is compared (340) with Ptc (330) that is the actual uplink transmission power required by the base station in the closed-loop power control command (namely the power expected to be transmitted by the terminal). If the difference between the actual uplink transmission power Ptc for closed-loop power control and the calculated Pto is higher than a closed-loop control threshold (this threshold is determined by specific engineering design, e.g. 3-6 dB), the.terminal will perform uplink transmission with the power equal to the sum of the expected transmitting power (Pto) for open-loop control and the threshold. If the difference thereof is not higher than the threshold, the terminal will continue to execute the closed-loop power control command and perform uplink transmission with the actual transmission power required by the base station in closed-loop power control. This threshold is used as a control to the uplink transmission power (level) so as to avoid “cocktail party effect” (360, 370); if the difference is not higher than this threshold, the terminal continues to execute the closed-loop power control command (350), namely perform uplink transmission with the actual uplink transmission power (level) Ptc required by the base station in closed-loop control (370).

With a pre-determined Preq, the required power level for receiving, the base station measures Eb/I and judges whether Eb/I has been always below the requirement of communication quality during a certain period of time (duration of the specific period is determined by engineering design), if the quality is always below the requirement of service (the required power level for receiving, Preq and the required code error rate, Eb/I) during the period, the required Eb/I and required signal power (level) for receiving Preq are to be adjusted (250). The modified Preq will then be transmitted to the terminal through higher layer downlink signaling (210, 220) while the terminal carries out other steps in the same way as mentioned above. If the communication quality is not below the quality required by the service for a certain period of time, closed-loop power control is maintained (230).

In the invention, no outer-loop power control need be employed at all while communications are maintained between the base station and the terminal. The Radio Network Controller (RNC) of the system is not involved in the power control process. What is needed for RNC is only to configure the base station, to set parameters in the base station, such as maximum transmission power and quality requirement by various services, according to the network design, rather than carrying out complex power control.

1. A power control method based on Downlink Piloting Time Slot (DwPTS), comprising an open-loop power control procedure while a terminal is being accessed randomly and a closed-loop power control procedure while communications are being maintained after the terminal is accessed, wherein
the open-loop power control procedure while a terminal is being accessed randomly comprises the steps of:
A. the terminal measuring received DwPTS signal powers transmitted by adjacent base stations during cell searching, sorting the base stations in the order of signal intensity of DwPTS, and determining candidate base stations;
B. the terminal calculating Uplink Piloting Time Slot (UpPTS) transmission power for open-loop power control while the terminal is being accessed according to the base station transmission power broadcasted by a candidate base station, the expected receiving powers and the DwPTS signal power of the base station actually measured by the terminal, and sending an access request to the base station with this transmission power; and wherein
the closed-loop power control procedure after the terminal is accessed comprises the steps of:
C. the base station determining required receiving power, determining actual uplink transmission power required by the base station for closed-loop power control, sending the required receiving power to the terminal by higher layer downlink signaling, and sending the actual uplink transmission power required by the base station to the terminal with a closed-loop power control command;
D. the terminal continuing to measure the actually received DwPTS signal power of the base station, then calculating an uplink transmission power reference value for open-loop power control according to the base station transmission power and the required receiving power; and
E. comparing the calculated uplink transmission power reference value under open-loop power control with the actual uplink transmission power required by the base station under closed-loop control and obtaining a difference, and comparing the difference with a threshold; if the difference is larger than the threshold, the terminal performing uplink transmission with the power which is equal to the sum of the calculated uplink transmission power reference value for open-loop power control and the threshold, if the difference is not larger than the threshold, the terminal continuing to execute the closed-loop power control command and performing uplink power transmission with the actual transmission power required by the base station for closed-loop power control.

2. A method according to claim 1, wherein, in said step A, the DwPTS signal powers transmitted by adjacent base- stations are the average values of multiple measurements of DwPTS signal powers.

3. A method according to claim 1, wherein, in step B, the transmission power of UpPTS for open-loop power control while the terminal is getting accessed equals the transmission power of DwPTS signal broadcasted by the base station minus the receiving power expected by the base station plus the received DwPTS signal power actually measured by the terminal plus an increment of transmission power of the terminal to avoid burst interference.

4. A method according to claim 1, further comprising: the terminal executing step B from the candidate base station with the largest DwPTS signal strength according to the sorting and waiting for a response from the base station after sending an access request; if the base station returns a response, determining that the access is successful, otherwise repeatedly executing step B for the current candidate base station or repeatedly executing step B for the candidate base station with the second largest DwPTS signal strength.

5. A method according to claim 1, wherein, in step C, the step of the base station determining the required receiving power further comprises: the base station measuring Eb/I of the uplink signals; from the terminal which are received when the terminal is getting accessed, and adjusting the required receiving power if the Eb/I is always below the communication quality requirement for a certain period of time.

6. A method according to claim 1, wherein, in step C, the step of the base station sending the actual uplink transmission power required by the base station to the terminal with a closed-loop power control command is executed when it is judged that the measured Eb/I of uplink signals is always not below a value sustaining the communication quality requirement for a certain period of time.

7. A method according to claim 5, wherein the communication quality requirement is the Eb/I determined according to service of quality requirement.

8. A method according to claim 6, wherein the communication quality requirement is the Eb/I determined according to service of quality requirement.

9. A method according to claim 1, wherein, in step D, the uplink transmission power reference value for open-loop power control equals DwPTS signal transmission power broadcasted by the base station minus the received DwPTS signal power of the base station actually measured by the terminal plus the receiving power expected by the base station.

10. A method according to claim 1, wherein, in step D, the received DwPTS signal power of the base station actually measured by the terminal is an averaged value for a certain period of time.

11. A method according to claim 1, wherein the threshold in the said step D is chosen between 3 dB and 6 dB according to specific engineering design.

12. A method according to claim 1, wherein a Radio Network Controller (RNC) does not participate in power control, and sets the maximum transmission power for each time-slot of the base station and setting quality requirements when the base station carries out various services, the maximum transmission power and the quality requirements being used when the base station determines the required receiving power and required Eb/I.

13. A power control method based on DwPTS, comprising an open-loop power control procedure while a terminal is being accessed randomly, wherein
the open-loop power control procedure while a terminal is getting accessed randomly comprises the steps of:
A. the terminal measuring received DwPTS signal powers transmitted by adjacent base stations during cell searching, sorting the base stations in the order of signal strength of DwPTS, and determining candidate base stations; and
B. the terminal obtaining UpPTS transmission power for open-loop power control while the terminal is getting accessed according to the base station transmission power broadcasted by a candidate base station, the expected receiving power and the DwPTS signal power of the base station actually measured by the terminal, and sending an access request to the base station with this transmission power.

14. A method according to claim 13, wherein, in step A, the DwPTS signal powers transmitted by adjacent base stations are the average values of multiple measurements of DwPTS signal powers.

15. A method according to claim 13, wherein, in step B, the transmission power of UpPTS under open-loop power control while the terminal is getting accessed equals the transmission power of DwPTS signal broadcasted by the base station minus the receiving power expected by the base station plus the received DwPTS signal power actually measured by the terminal plus an increment of transmission power of the terminal to avoid burst interference.

16. A method according to claim 13, further comprising: the terminal executing step B from the candidate base station with the largest DwPTS signal strength according to the sorting and waiting for a response from the base station after sending an access request; if the base station returns a response, determining that the access is successful, otherwise repeatedly executing step B for the current candidate base station or repeatedly executing step B for the candidate base station with the second largest DwPTS signal strength.

17. A power control method based on DwPTS, comprising a closed-loop power control procedure while communications are being maintained after the terminal is accessed, wherein
the said closed-loop power control procedure after the terminal is accessed comprising the steps of:
C. the base station determining the required receiving power, determining actual uplink transmission power required by the base station for closed-loop power control, sending the required receiving power to the terminal by higher layer downlink signaling, and sending the actual uplink transmission power required by the base station to the terminal with a closed-loop power control command;
D. the terminal keeping measuring the actually received DwPTS signal power of the base station, then calculating an uplink transmission power reference value for open-loop power control according to the base station transmission power and the required receiving power; and
E. comparing the calculated uplink transmission power reference value under open-loop power control with the actual uplink transmission power required by the base station for closed-loop control and obtaining a difference, comparing the difference with a threshold; if the difference is larger than the threshold, the terminal performing uplink transmission with the power which is equal to the sum of the calculated uplink transmission power reference value for open-loop power control and the threshold, if the difference is not larger than the threshold, the terminal continuing to execute the closed-loop power control command and performing uplink power transmission with the actual transmission power required by the base station for closed-loop power control.

18. A method according to claim 17, wherein, in step C, the step of the base station determining the.required receiving power further comprises: the base station measuring Eb/I of the uplink signals from the terminal which are received when the terminal is getting accessed, and adjusting the required receiving power if the Eb/I is always below a value sustaining the communication quality requirement for a certain period of time.

19. A method according to claim 17, wherein, said step C, the step of the base station sending the actual uplink transmission power required by the base station.to the terminal with a closed-loop power control command is executed when it is judged that the measured Eb/I of uplink signals is always not below a value sustaining the communication quality requirement for a certain period of time.

20. A method according to claim 17, wherein, in step D, the said uplink transmission power reference value for open-loop power control equals DwPTS signal transmission power broadcasted by the base station minus the received DwPTS signal power of the base station actually measured by the terminal plus the receiving power expected by the base station.

21. A method according to claim 20, wherein, in step D, the received DwPTS signal power of the base station actually measured by the terminal is an averaged value for a certain period of time.

22. A method according to claim 17, wherein, in step D, the received DwPTS signal power of the base station actually measured by the terminal is an averaged value for a certain period of time.

23. A method according to claim 17, wherein the said threshold in the said step D is chosen between 3 dB and 6 dB according to specific engineering design.
